(19) United States
(12) Patent Application Publication
(10) Pub. No.: US 2021/0276041 A1
(43) Pub. Date: Sep. 9, 2021

(54) SPACER FOR PAINTING UNDERNEATH DOOR KNOBS, AND RELATED METHODS OF PRODUCTION AND USAGE

(71) Applicant: Ryan Jacob Houck, Philomath, OR (US)

(72) Inventor: Ryan Jacob Houck, Philomath, OR (US)

(21) Appl. No.: 16/812,337

(22) Filed: Mar. 8, 2020

(51) Int. Cl. B05D 1/32

(52) U.S. Cl. CPC B05D 1/32

(57) ABSTRACT

A spacer for painting between a door handles flange and the door without the removal of the door knob. The door handle spacer is constructed of a single piece wider than the door with an open center and access in one side allowing assembly and operation of the knob. First the spacer is inserted into the hole in the door then the knob is assembled through the spacer. The spacer may be inserted into the hole in the door, without any tools. Opposite the access for the plunger is a hole for a wood screw that can be used to fasten the spacer to the door.

### BACKGROUND

### 1. Field of the Invention

This invention relates to construction, specifically this invention increases the speed and efficiency of painting doors.

### 2. General Background

Doors are an essential part of any structure, they allow entry while blocking out many things such as light, cold or hot air, and other people. Typically doors and latches are still required during construction for these reasons. Often doors are painted a color that matches the rest of the structure, while the latch or knob typically has a separate finish from the door.

In many cases a temporary knob is put on to avoid painting and damage to the final knob during construction. There have been two ways to paint a door with a knob installed on it, paint around the knob or remove the knob; both of which have disadvantages.

In the case of leaving the knob on the door and painting around it there is an area of the door that remains unpainted. A problem arises when the temporary knob covers a different area of the door than the final knob, leaving an unpainted area visible on the door with the final knob. Touch-up paint is required when unpainted area shows.

If the knob is removed for painting the painter will have to take time to remove and reinstall the knob on the door. Often the knob must be reinstalled to secure the structure before the paint has had a chance to fully dry. When the knob is installed before the paint is dry it leaves a ring in the paint where the flange of the knob was clamped onto the door. If this ring is visible when the final knob is installed touch-up will be required, which typically will consist of sanding out the ring and repainting.

### SUMMARY

### Overview

The inventions purpose is to reduce the time spent on touch-ups to a door after painting when the knob must be installed on the door before the paint is dry, while providing a firm base for the knob.

To do this the invention is a spacer made from a single piece of material, wider than the door, that fits into the existing hole in a door used for the mechanisms of the knob. The knob clamps onto the spacer, that is wider than the door, leaving space between the knob and door allowing the use of a brush, spraying, or equivalent without leaving an unpainted area on the door or defects on the door from clamping onto the door before the paint has fully dried.

### Usage

The spacer, M, is pressed, by hand, into the hole in the door for the knob, N, aligning the access for the plunger, Q, with the cross hole, R, in the door for the plunger, L. If more rigidity is required there is a hole, G, for a fastener to fasten the spacer to the door until removal of the spacer is required.

### BRIEF DESCRIPTION OF THE DRAWINGS

The typical design of the door handle spacer will now be described with references to the accompanying figures. The drawings are:

FIG. 1 is a side view of the door handle spacer.

FIG. 2 is a front view of the door handle spacer.

FIG. 3 is an isometric view of the door handle spacer.

FIG. 4 is a section view called out in FIG. 1 taken at line 4-4.

FIG. 5 is an exploded isometric view of the typical installation of the door handle spacer.

FIG. 6 is a diagram showing the typical steps for using the door handle spacer.

### DETAILED DESCRIPTION

Next is a detailed description of the preferred embodiment, drawings, production, and usage. However this invention is not limited to these details and examples.

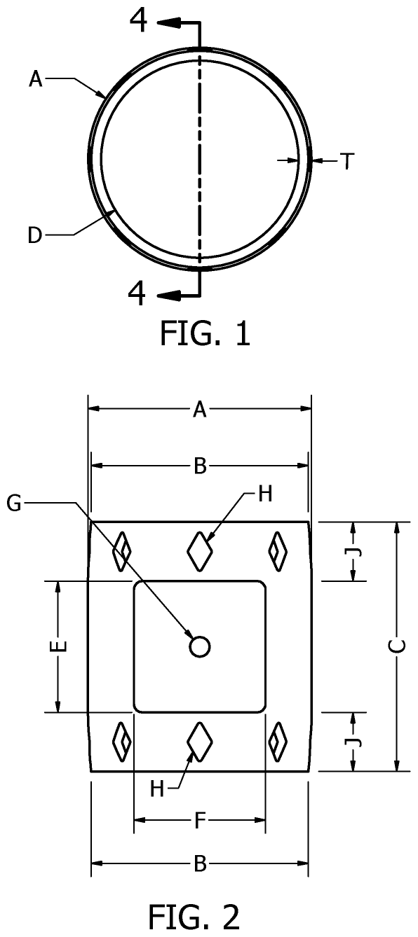

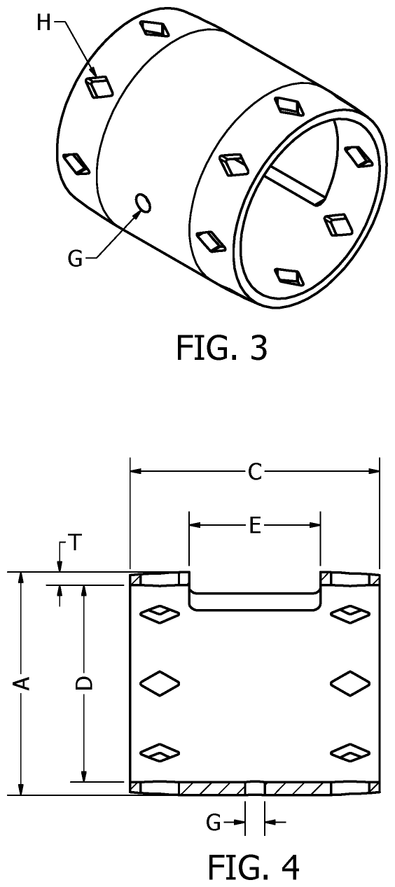

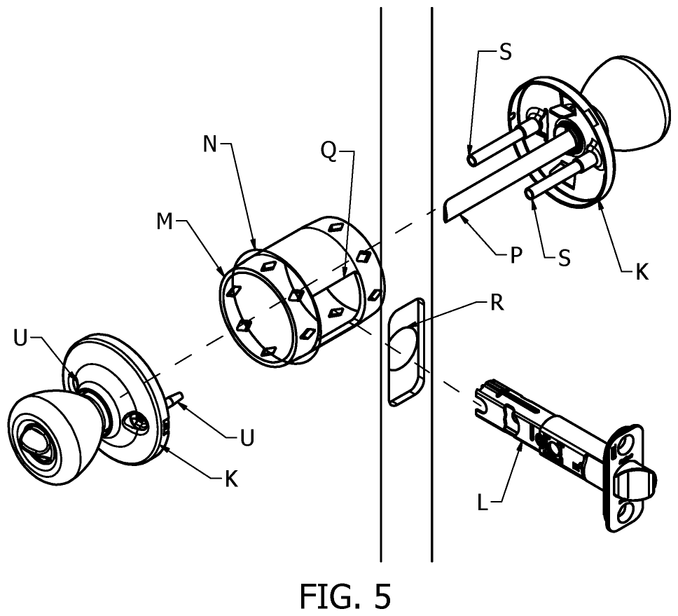

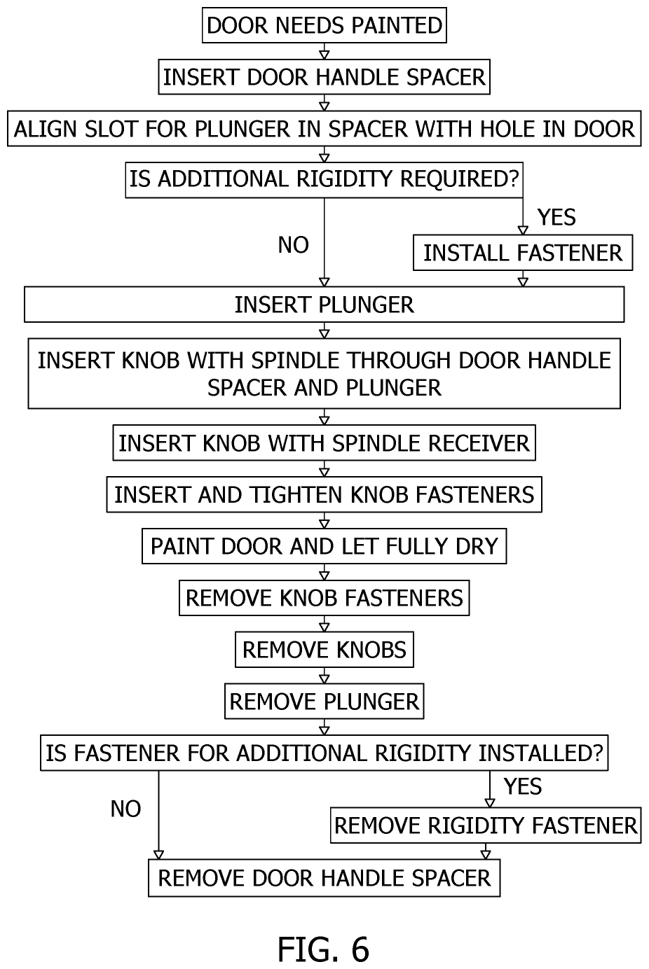

FIGS. 1-4 show the specific features and dimensions making up the door handle spacer. FIGS. 1, 2, and 4 show overall dimensions of outside diameter A, inside diameter D, thickness T, and length C. FIGS. 2, 3, and 4 show specific features of length and width of the plunger access with dimensions E and F respectively, hole with diameter of G, taper from outside diameter A to diameter B over length J, and cutout H. FIG. 5 shows the door handle spacer, M, installed in the door hole for a knob, N, with the door handle spacers plunger access, Q, aligned with the door plunger hole, R, and an example knob with flange K, spindle P, barrel nuts S, screws U, and plunger L. FIG. 6 is a diagram showing the typical usage of the door handle spacer.

Outside diameter A is sized and tolerance to be a tight slip fit or press fit that requires no tools to insert into door hole N, where the diameter of the door hole N can vary between manufactures but is typically a nominal 2 ⅛ inch. Outside diameter A is designed as the nominal of the door hole N −0.020+0.003 inch. Outside diameter A typically favors the lower tolerance because many door are made of wood; which is known to expand, contract, and warp with changes in environmental conditions, specifically moisture. Therefore outside diameter A favoring the lower tolerance will ensure that the door handle spacer, M, consistently fits into the door hole, N.

The door handle spacer, M, has inside diameter, D, allowing components of the knob to pass through and function, therefore the inside diameter, D, may vary depending on the style and manufacturer of the knob but typically depends on spacing of barrel nuts, S. Inside diameter D is also dependent on outside diameter A to maintain wall thickness T so the door handle spacer does not break from the clamping of the door knobs flanges or usage of the door knob. Inside diameter D is typically 1 ⅞± 1/16 inch resulting in thickness T is typically ⅛ inch.

The door handle spacer M has a length C sized to be greater than the thickness of the door, but not large enough to prevent the knobs screws U from engaging the barrel nuts S. Length C also has dependence on the knobs flange K, because door handle spacer M typically will fit inside flange K. With an approximate door thickness of 1 11/16 inch length C is typically 2 ⅜± 1/16 inch and creates an approximate gap between knob flange K and the door of ⅛ inch. This gap allows painting the area of the door that would otherwise be covered by knob flange K without the removal of the knob.

Plunger access Q was made of a rectangular hole with length E and width F, but is not required to be rectangular. For example Q could be a circle which is easily drilled into a tube, or length E could be as large as length C meaning FIG. 1 would be C-shaped instead of a closed circle. Length E and width F have a minimum of the size of the plunger L, but for ease of installation should be larger, both are typically 1 ¼ inch.

The door handle spacer M has a hole G across from plunger access Q. Hole G allows for a fastener to secure door handle spacer M to the door. The fastener will usually be a small wood screw installed through the door plunger hole R and plunger access Q. Hole G will typically have a diameter of 3/16 inch.

To facilitate insertion into door hole N door handle spacer M has tapered outside diameter on both ends. The taper reduces outside diameter A to diameter B over length J, creating a small section of door handle spacer M that aligns with door hole N easily before the press fit of outside diameter A. Taper length J is typically 5/16 inch and diameter B is typically 2 1/16± 1/16 inch.

Cutout H is intended to reduce the amount of material used to make the door handle spacer, reducing manufacturing cost. The method of manufacturing of the current door handle spacer is 3D printing, which dictates the best shape of cutout H to reduce material usage is a diamond of specific angles such that no support material is required. The maximum angle without support is different for each 3D printing material. However H is not required for the functions of the door handle spacer, and therefore is not required. If subtractive manufacturing processes are used, such as machining the door handle spacer out of a round bar, or cutting out a flat plate then forming to size, cutout H would increase cost of manufacturing and therefore would not be included.

The present method of manufacturing the door handle spacer is 3D printing plastic, a method of additive manufacturing where small layers of plastic are laid over top of each other typically starting on top of a glass plate and building up. 3D printing plastics typically start as a wire which is melted onto the glass or strips of plastic already laid down building up the final object. The 3D printer uses a computer generated model as instruction to lay down the strips of material. Due to this nature of 3D printing the addition any feature that reduces the mass of the final object will typically reduce the time taken to make the part, reducing cost of the part. This reduction of cost is the intent of cutout H on the door handle spacer. Cutout H forms what is called a bridge or overhang, an area where printing is required without any material directly below to support it. An overhang with an angle up from the build plate of 40 degrees or more will not require any removable support material to be generated. This overhang angle is dependent on many factors such as the features of the 3D printer, printing rate, cleanliness of the print head, type of material used, and many more. Cutout H was given the same angle on both top and bottom to allow printing of the door handle spacer in either direction without requiring support material in the cutout.

With 3D printing a further reduction of material is possible by making dimension E equal to dimension C, and increasing dimension D where the rigidity requirement allows. Further cost savings may be realized by adding more holes or cutouts, further reducing the material usage and time to manufacture.

The door handle spacer may also be manufactured with a number of other processes and materials such as, but not limited to, 3D printing with metal, machining, casting, injection molding, and forming (rolling or bending) of sheets. The process used for manufacturing will also dictate features to include.

For example in machining and forming any feature that increase time increases cost. Machining the door handle spacer from a bar, tube, extrusion, or similar, would not include cutout H because it would take more machining time to include. Also with machining plunger access Q could be a drilled hole to reduce machining time, however with forming dimension E would most likely become equal in value to dimension C by starting with a narrower sheet of material to form and producing a C-shaped cross section.

The material presently comprising the door handle spacer is 3D printable plastic, but other materials can be used, including but not limited to other plastic types, metal, rubber, and wood. If greater strength of the door handle spacer is required metals would likely be used with a manufacturing process of machining, casting, or forming. For high volume production typically metal or plastic have the lowest cost per part produced in a process such as casting or injection molding, but these processes have the drawback of high tooling cost upfront for the making of the molds. Since some types of rubber and plastics are flexible they could be utilized when a single door handle spacer must work with doors that have different dimensions for hole N.

1-31. (canceled)

32: A door handle spacer for coating between the door and the flange of the doors knob without the removal and re-installation of the knob on the door, while providing a rigid connection between knob and door, without leaving uncoated area behind the door knob flange, comprised of a round tube with tapered ends, a hole for an optional fastener, and accesses for the knobs plunger and other mechanical components, with typical nominal outside diameter of 2 ⅛ inch.

33: The door handle spacer of claim 32, creates space, typically ⅛ inch, for coating between the knobs flange and the door, by providing a surface for knob mounting wider than the door, yielding a typical door handle spacer length of 2 ⅜± 1/16 inch, however different styles of knobs and doors may require different lengths of door handle spacers.

34: The door handle spacer of claim 32, has an access in the side of the tube for the mechanical parts of the knob such as spindle, fasteners, and other knob components, through the center of the door handle spacer typically as inside diameter of 1 ⅞± 1/16 inch.

35: The door handle spacer of claim 32 further comprising of access for the knobs plunger to pass through and mate with the spindle after the door handle spacer has been inserted into the door, with a width and height no smaller than the diameter of the plunger, but the width of the plunger access may extend the entire length of the spacer, typically both dimensions are 1 ¼ inch.

36: The door handle spacer of claim 32, maintains a rigid connection between knob and door, due to the tight slip fit or press fit into the doors hole, which may be inserted by hand without any tools, and aided by an optional fastener.

37: The door handle spacer of claim 36, has a press fit into the doors hole, which insertion can be helped by a chamfer, radius, or similar to align the door handle spacer with the doors hole.

38: The door handle spacer of claim 36 is capable of being inserted into the door by hand, without any tools, because the device is comprised of a round tube with dimensions of the doors hole +0.003−0.020 inch, with a typical nominal value of 2 ⅛, but the doors hole diameter can vary among manufactures.

39: The door handle spacer of claim 36 has the option to use a fastener to temporarily join with the door, which is installed through a hole, of 3/16 inch diameter typically, in the device across from the plunger access so that the plunger access hole can be used to access the fastener hole once the door handle spacer is installed.

40: The door handle spacer of claim 32, is inserted into the door first, next the optional fastener for added rigidity is installed, then the knob is assembled through the door handle spacer, and then the door is coated and left to dry or cure; removal is the reverse of installation.

41: The door handle spacer of claim 40 remain on the door while the coating is drying or curing, by allowing the knob to latch, unlatch, and lock the door while installed.

42: The method of production of the door handle spacer, techniques of 3D printing with plastic, allowing for holes or cutouts that reduce the material usage.

43: The method of producing of claim 42 utilizing 3D printing, but alternate embodiment may be produced by, but not limited to, machining, casting, injection molding, and forming.

44: The method of production of claim 42 utilizing plastic, but alternate embodiment may be made of, but not limited to, metal, rubber, and wood.

45: The methods of production of claim 42 wherein a series of cutouts to reduce the material usage in manufacturing, with a typical minimum overhang angle of 40 degrees to avoid the need of removable support material, however the angle varies depending on many factors such as 3D printer features and type of plastic used.

46: The method of usage of the door handle spacer first inserting the door handle spacer into the doors knob hole, next the optional fastener may be installed, then the knob is assembled through the door handle spacer, next the door is coated with the knob and door handle spacer installed in the door, the coating is then allowed to fully dry or cure before the knob and spacer are removed from the door, while allowing normal operation of the door and knob while the door handle spacer and knob are installed on the door.

47: The method of use of the door handle spacer of claim 46 wherein the door handle spacer is first inserted into the doors hole with a tight slip fit or press fit, requiring no tools to insert, where alignment between the door handle spacer and door is helped by the door handle spacers radius, chamfer, or similar feature.

48: The method of use of claim 46 wherein an optional faster may be installed to provide additional rigidity to the connection between door and door handle spacer, typically the plunger hole in both the door and door handle spacer provides the access to the hole for the fastener in the door handle spacer.

49: The method of use of claim 46 wherein the knob is assembled through the door handle spacer, after the door handle spacer and optional fastener have been installed in the door, clamping onto the door handle spacer with the ring of the knob creating a gap between the ring of the knob and the door.

50: The method of use of claim 46 wherein the door is coated while the knob and door handle spacer are installed on the door, allowing coating behind the flanges of the knob, leaving no uncoated area on the door.

51: The method of use of claim 46 wherein knob and door handle spacer remain installed on the door until the coating is dry or cured, reducing the defects in the coating of the door, additionally the knob and door handle spacer typically remain installed in the door until the next knob is ready to be installed to reduce defects in the coating on the door.

52: The method of use of claim 46 wherein the door and knob operate in standard way while the door handle spacer is installed, allowing removal once the next knob is ready to be installed.
